(19) United States
(12) Patent Application Publication
(10) Pub. No.: US 2006/0202931 A1
(43) Pub. Date: Sep. 14, 2006

(54) Electro-optical device, method of manufacturing electro-optical device, and electronic apparatus

(75) Inventor: Shin Koide, Chino (JP)

Correspondence Address: HARNESS, DICKEY & PIERCE, P.L.C., P.O. BOX 828, BLOOMFIELD HILLS, MI, 48303, US

(73) Assignee: Sanyo Epson Imaging Devices Corporation

(21) Appl. No.: 11/330,306

(22) Filed: Jan. 11, 2006

(30) Foreign Application Priority Data
Mar. 8, 2005 (JP) 2005-63423(P)

(51) Int. Cl. G09G 3/36

(52) U.S. Cl. 345/90

(57) ABSTRACT

An electro-optical device includes a first substrate and a second substrate disposed so as to be opposite to each other; a driving circuit part that has a polycrystalline semiconductor layer and is provided on a surface of the first substrate opposite to the second substrate; a first connecting part that is provided on the surface of the first substrate opposite to the second substrate so as to be electrically connected to the driving circuit part; pixel electrodes that are provided on a surface of the second substrate opposite to the first substrate; and a second connecting part that is provided on the surface of the second substrate opposite to the first substrate so as to be electrically connected to the pixel electrodes. The first connecting part and the second connecting part are electrically connected to each other in a region where the first connecting part and the second connecting part overlap each other in plan view.

### BACKGROUND

1. Technical Field

The present invention relates to an electro-optical device, to a method of manufacturing the same, and to an electronic apparatus.

2. Related Art

In general, a technique of forming a pixel part having pixel switching elements, such as thin film transistors (hereinafter, referred to as TFTs), and a driving circuit for supplying driving signals to the pixel part on the same substrate has been known as a technique for narrowing a frame of an active matrix electro-optical device and for reducing the power consumption of the device. When the driving circuit is formed on an element substrate by using a semiconductor film, the driving capability of a driving circuit using an amorphous semiconductor film is insufficient. Therefore, it has been attempted to form both the pixel switching elements and the driving circuit by using polysilicon semiconductor layers.

For example, JP-A-2002-258765 discloses an electro-optical device in which switching elements of a pixel part and a scanning line driving circuit are formed on an element substrate by the same low-temperature polysilicon process. Also, JP-A-8-250745 discloses a technique for constituting an electro-optical device by forming driving circuits on a driving circuit substrate separately formed from an element substrate by using a low-temperature polysilicon process, and then by bonding a driving circuit obtained by cutting the driving circuit substrate to the element substrate.

However, the former is effective to narrow a frame, but has a problem in that the process becomes complicated because the pixel part and the driving circuit are formed at the same time, resulting in low yield. Further, in the latter, a circuit piece separately prepared is mounted on the element substrate. Therefore, a layout area as large as an electro-optical device using IC chips according to the related art is required, and thus the latter does not contribute to a narrow frame. Furthermore, the driving circuit formed by using the low-temperature polysilicon process has lower static electricity resistance than IC chips, and thus it is required to carefully handle the driving circuit.

### SUMMARY

An advantage of some aspects of the invention is that it provides an electro-optical device having a driving circuit and capable of being manufactured by a simple process with high yield, and a method of manufacturing the same.

According to a first aspect of the invention, An electro-optical device includes a first substrate and a second substrate disposed so as to be opposite to each other; a driving circuit part that has a polycrystalline semiconductor layer and is provided on a surface of the first substrate opposite to the second substrate; a first connecting part that is provided on the surface of the first substrate opposite to the second substrate so as to be electrically connected to the driving circuit part; pixel electrodes that are provided on a surface of the second substrate opposite to the first substrate; and a second connecting part that is provided on the surface of the second substrate opposite to the first substrate so as to be electrically connected to the pixel electrodes. In the electro-optical device, the first connecting part and the second connecting part are electrically connected to each other in a region where the first connecting part and the second connecting part overlap each other in plan view.

According to this configuration, since the pixel electrodes constituting the main part of the display region of the electro-optical device and the driving circuit part for supplying electric signals to the pixel electrodes are provided on different substrates, it is possible to separately perform forming the driving circuit part on the first substrate and forming the pixel electrodes on the second substrate. Therefore, it is possible to perform a photolithography process capable of obtaining the minimum line width on the driving circuit part requiring high-speed operation and the improvement of the integration degree and thus to improve the integration degree and operation speed of the driving circuit part.

Further, it is possible to apply a photolithography process capable of uniformly processing regions on a substrate to pixel electrode forming regions that should be uniformly formed on the entire display region. Furthermore, it is possible to perform high-quality display Without display irregularity by suppressing a variation in switching characteristics in the display region.

In addition, since a process most suitable for forming both the driving circuit part and the pixel part can be used, it is possible to improve the performance and yield of both the driving circuit part and the pixel electrode forming region.

In the electrical connection between the driving circuit part and the pixel electrodes, the first connecting part and the second connecting part electrically connected to the driving circuit part and the pixel electrodes, respectively, are formed so as to overlap each other in plan view when the first substrate and the second substrate are bonded to each other, so that the first and second connecting parts are electrically connected to each other. Therefore, simultaneously with the bonding of the first substrate and the second substrate, the first connecting part and the second connecting part are electrically connected to each other, which results in a reduction in the number of processes.

Therefore, according to this configuration, it is possible to provide a compact electro-optical device having a high-performance driving circuit, which can perform high quality display and be manufactured with high yield by a simply process.

Further, in this invention, a ‘pixel electrode’ means a voltage applying unit for applying a voltage to an electro-optical material in a pixel, and is not necessarily an electrode formed for every pixel. For example, a strip-shaped electrode extending across a plurality of pixels is also included in the ‘pixel electrode’.

In this specification, ‘electro-optical devices’ include light emitting devices for converting electric energy into optical energy, in addition to devices having an electro-optical effect in which light transmittance varies according to the change of the refractive index of a material by an electric field.

In the electro-optical device according to the first aspect of the invention, it is preferable that the first connecting part and the second connecting part be electrically connected to each other by a conductive member that is interposed between the first substrate and the second substrate. According to this configuration, it is possible to easily electrically connect the first connecting part and the second connecting part by disposing the conductive member on the first substrate or the second substrate at the time when the first substrate and the second substrate are bonded to each other. Thus, it is possible to very easily manufacture an electro-optical device.

Further, in the electro-optical device according to the first aspect of the invention, the conductive member electrically connecting the first connecting part and the second connecting part may form at least a part of a sealing material that bonds the first substrate to the second substrate. According to this configuration, since the bonding material for bonding the first substrate to the second substrate also has a function for electrically connecting the first connecting part and the second connecting part, it is possible to further improve the manufacture efficiency.

Furthermore, in the electro-optical device according to the first aspect of the invention, the first connecting part and the second connecting part may be disposed on the outside of the sealing material for bonding the first substrate to the second substrate. When the first connecting part and the second connecting part are formed on the inside of the sealing material, it is possible to protect the electrical connection structure of the two connecting parts from the air by the sealing material and thus to improve the electrical reliability of the above-mentioned electrical connection structure. However, there is a case in which an electro-optical material, such as liquid crystal is sealed on the inside of the sealing material. In this case, when the first connecting part and the second connecting part are formed on the inside of the sealing material, there is a possibility that a conductive member for connecting the connecting parts will come into contact with the electro-optical material, resulting in the deterioration of the electro-optical material. However, according to the above-mentioned configuration, since the connecting parts are disposed on the outside of the sealing material, it is possible to easily prevent contact between the electro-optical material and a constituent element regarding the electrical connection structure of the first connecting part and the second connecting part.

Furthermore, in the electro-optical device according to the first aspect of the invention, preferably, the first connecting part and the second connecting part each include a plurality of connecting terminals. In addition, preferably, the connecting terminals of the first connecting part and the connecting terminals of the second connecting part are electrically connected to each other by an anisotropic conductive material provided between the first substrate and the second substrate. Generally, the driving circuit part and the pixel electrodes are connected by a plurality of connecting wiring lines. In this configuration, a plurality of connecting wiring lines extending from the driving circuit part are electrically connected to the plurality of connecting terminals of the first connecting part, and a plurality of connecting wiring lines extending from the pixel electrodes are electrically connected to the plurality of connecting terminals of the second connecting part. In addition, a conductive member formed of an anisotropic conductive material is provided between the first connecting part and the second connecting part. Therefore, it is possible to easily electrically connect the plurality of connecting terminals of the first connecting part to the plurality of connecting terminals of the second connecting part at the time when the first substrate and the second substrate are bonded to each other. In this way, it is possible to efficiently form an electrical connection structure between the driving circuit part and the pixel part.

Furthermore, in the electro-optical device according to the first aspect of the invention, preferably, the driving circuit part includes a pixel part driving circuit that supplies driving signals to the pixel electrodes; a signal processing circuit that performs signal processing on an image signal input from the outside and outputs the processed signal to the pixel part driving circuit; and a power supply circuit that supplies power to the pixel part driving circuit. That is, the electro-optical device according to the first aspect of the invention can have a configuration in which the signal processing circuit and the power supply circuit, which have been provided as external circuits in the related art, are mounted on one substrate together with the pixel part driving circuit for supplying driving signals to the pixel electrodes. According to this configuration, it is unnecessary to connect the wiring substrate having the above-mentioned circuits mounted thereon to another electro-optical device, and thus to reduce the size of an electro-optical device. Further, it is also possible to use a small-sized wiring substrate to be mounted on the electro-optical device in an electronic apparatus, and thus it is possible to obtain an electro-optical device that can be easily treated at the time of bonding and has high workability.

Furthermore, in the electro-optical device according to the first aspect of the invention, preferably, color filters are formed in a region of the first substrate overlapping a region where the pixel electrodes are formed in plan view. Alternately, preferably, color filters are formed in a region of the second substrate overlapping a region where the pixel electrodes are formed in plan view. In these configurations, it is possible to obtain an electro-optical device capable of performing color display with high quality. In this case, the driving circuit part including a polycrystalline semiconductor layer has relatively low static electricity resistance. Therefore, when the color filters are formed in a portion of the second substrate not having the driving circuit part, it is possible to reduce the effect of static electricity on the driving circuit part by supplying the first substrate on which the driving circuit is formed to another process, and thus the improvement of the yield can be expected.

Furthermore, in the electro-optical device according to the first aspect of the invention, preferably, a plurality of scanning lines and a plurality of data lines are formed on the second substrate so as to intersect each other, and thin film transistors electrically connected to the pixel electrodes are provided corresponding to intersections of the scanning lines and the data lines. In addition, preferably, the second connecting part has a plurality of scanning-line-driving-circuit-side pixel connecting terminals electrically connected to the plurality of scanning lines and a plurality of data-line-driving-circuit-side pixel connecting terminals electrically connected to the plurality of data lines, and the driving circuit part of the first substrate has a scanning line driving circuit that supplies electric signals to the scanning lines and a data line driving circuit that supplies electric signals to the data lines. Further, preferably, the first connecting part has a plurality of scanning-line-driving-circuit connecting terminals electrically connected to the scanning line driving circuit and a plurality of data-line-driving-circuit connecting terminals electrically connected to the data line driving circuit. Furthermore, it is preferable that the scanning-line-driving-circuit-side pixel connecting terminals and the scanning-line-driving-circuit connecting terminals be electrically connected to each other and that the data-line-driving-circuit-side pixel connecting terminals and the data-line-driving-circuit connecting terminals be electrically connected to each other.

According to a second aspect of the invention, a method of manufacturing an electro-optical device includes forming a driving circuit part having a polycrystalline semiconductor layer and a first connecting part electrically connected to the driving circuit part on one surface of a first substrate; forming pixel electrodes and a second connecting part electrically connected to the pixel electrodes on one surface of a second substrate; and bonding the first substrate to the second substrate so that the first connecting part of the first substrate and the second connecting part of the second substrate are opposite to each other, thereby electrically connecting the first connecting part and the second connecting part.

In this manufacturing method according to the second embodiment, the driving circuit part and the pixel electrodes are formed on different substrates, and are electrically connected to each other by bonding the first substrate to the second substrate. Therefore, it is possible to form the driving circuit part requiring a high degree of integration for improving the functionality by using a photolithography process capable of obtaining the minimum line width. As a result, it is possible to improve the integration degree and operation speed of the driving circuit part. Further, it is possible to form the pixel electrodes, which requires uniformity over the entire display region, in pixel electrode forming regions by applying a photolithography process capable of performing a uniform process in regions on a substrate. Therefore, it is possible to perform high-quality display without display irregularity by suppressing a variation in switching characteristics in the display region.

Therefore, according to the manufacturing method according to the second aspect of the invention, it is possible to easily and efficiently manufacture an electro-optical device having a high-performance driving circuit part and a display region having a uniform display characteristic.

In the manufacturing method of an electro-optical device according to the second aspect of the invention, it is preferable to electrically connecting the first connecting part and the second connecting part by bonding the first substrate to the second substrate with the conductive member interposed therebetween.

According to this manufacturing method according to the second aspect, it is possible to form the electrical connection structure of the first connecting part and the second connecting part simultaneously with the bonding of the first substrate and the second substrate, and thus it is possible to easily and efficiently manufacture an electro-optical device.

In the method of manufacturing an electro-optical device according to the second aspect of the invention, it is preferable to use a conductive member containing an anisotropic material as the above-mentioned conductive member. According to this configuration, when the first connecting part and the second connecting part each include a plurality of connecting terminals, the conductive member containing the anisotropic conductive member is provided between the first connecting pat and the second connecting part, which makes it possible to reliably electrically connect the connecting terminals of the first connecting part and the connecting terminals of the second connecting part disposed to be opposite to each other, and to prevent a short circuit between adjacent connecting terminals. Therefore, according to this manufacturing method, it is possible to manufacture an electro-optical device having an electrical connection structure with high reliability by a simple process.

According to a third aspect of the invention, an electronic apparatus includes the electro-optical device. According to this configuration, a high-performance driving circuit is mounted on a panel, and thus it is possible to realize an electronic apparatus that has a compact display unit with high controllability and excellent mountability.

### BRIEF DESCRIPTION OF THE DRAWINGS

The invention will be described with reference to the accompanying drawings, wherein like numbers reference like elements.

FIG. 1 is a perspective view showing the configuration of a liquid crystal device according to a first embodiment of the invention.

FIG. 2 is a view showing the electrical configuration of the liquid crystal device.

FIG. 3A is a plan view showing the configuration of one of two substrates constituting the liquid crystal device.

FIG. 3B is a plan view showing the configuration of the other of two substrates constituting the liquid crystal device.

FIG. 4 is a cross-sectional view taken along the line IV-IV of FIG. 3A.

FIG. 5 is an explanatory view schematically showing the plane-view structure of a connection region shown in FIG. 4.

FIGS. 6A and 6B are views showing a manufacturing method of a liquid crystal device according to a second embodiment.

FIGS. 7A and 7B are views showing a manufacturing method of a liquid crystal device according to a third embodiment.

FIG. 8 is a perspective view showing an example of an electronic apparatus according to a fourth embodiment.

### DESCRIPTION OF EXEMPLARY EMBODIMENTS

Liquid Crystal Device

Preferred embodiments of the invention will be described with reference to the accompanying drawings. This embodiment relates to an active matrix liquid crystal device using TFTs to which an electro-optical device according to the invention is applied.

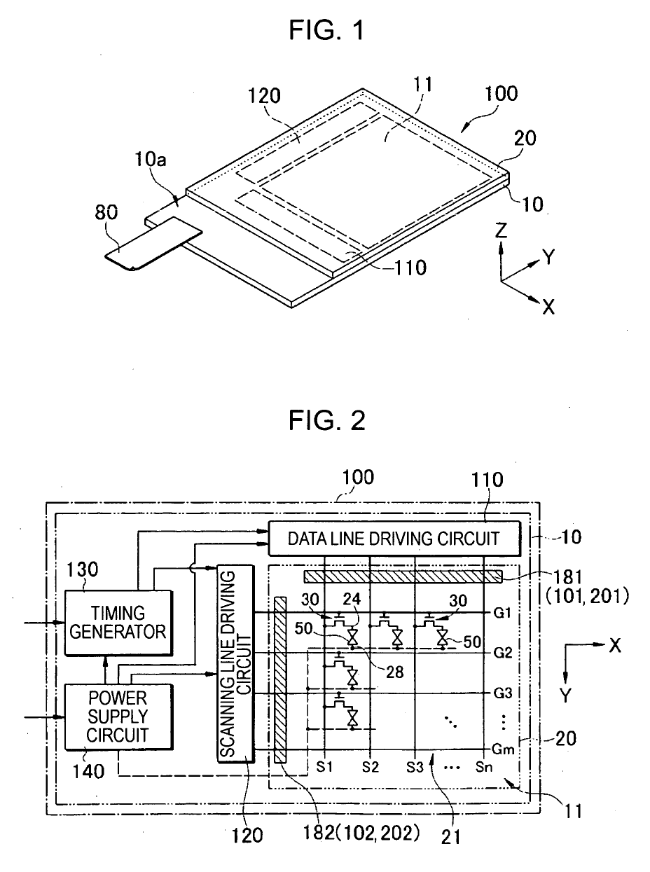

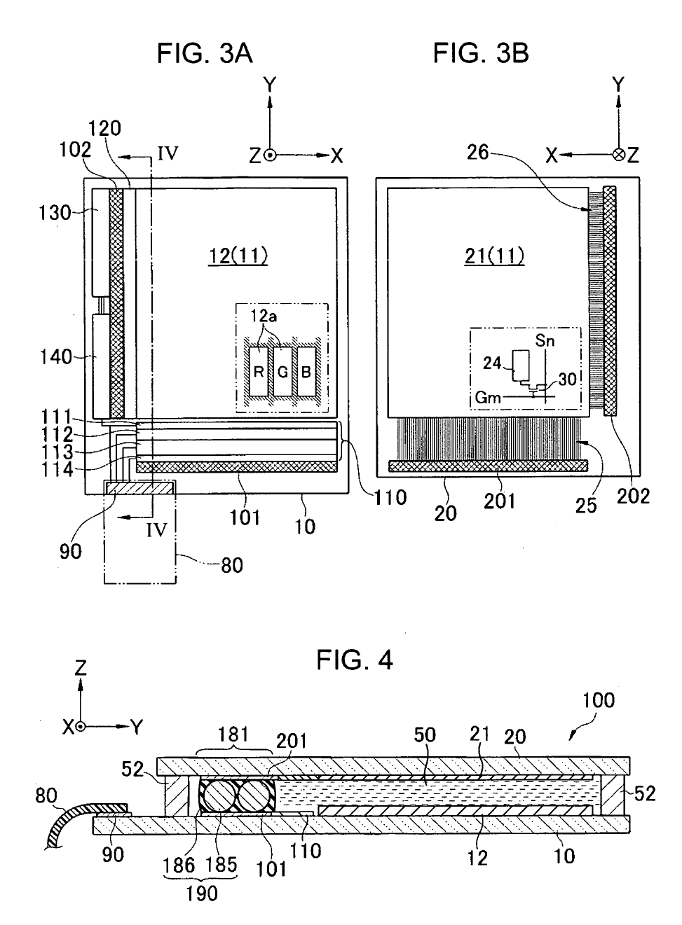

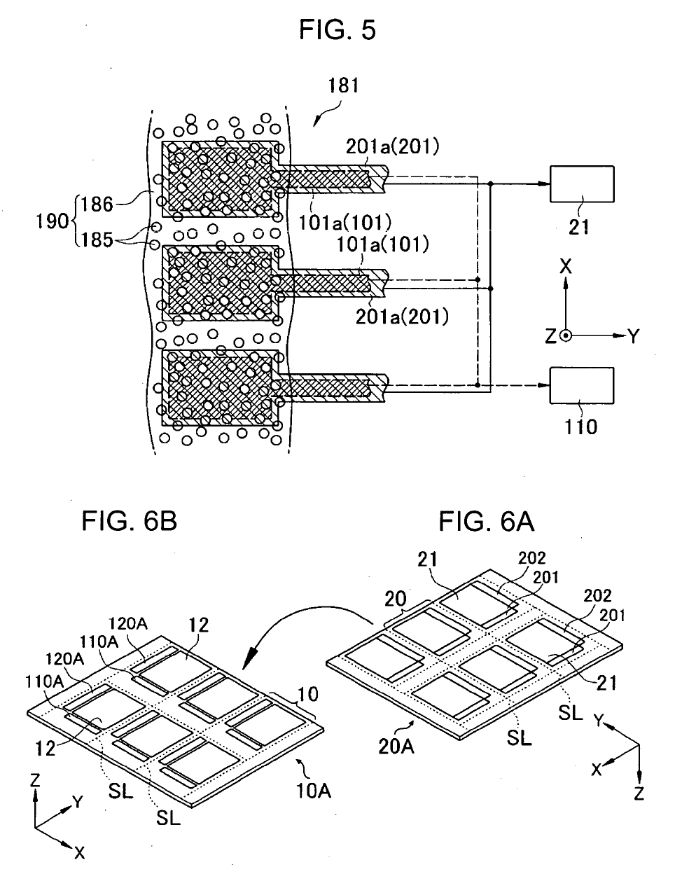

FIG. 1 is a perspective view showing the configuration of the liquid crystal device according to this embodiment. FIG. 2 is a circuit diagram of the liquid crystal device. FIG. 3A is a plan view showing the configuration of one of two substrates constituting the liquid crystal device, and FIG. 3B is a plan view showing the configuration of the other of two substrates constituting the liquid crystal device. FIG. 4 is a cross-sectional view taken along the line IV-IV of FIG. 3A. FIG. 5 is an explanatory view partially showing the plane-view structure of a connection region 181 shown in FIG. 4.

As shown in FIG. 1, a liquid crystal device 100 has a driving circuit substrate (first substrate) 10 and a pixel forming substrate (second substrate) 20 which are disposed opposite to each other. Further, the driving circuit substrate 10 and the pixel forming substrate 20 are bonded to each other by a sealing material (bonding material) 52 provided the edges of their surfaces opposite to each other, as shown in FIG. 3A. The substrates 10 and 20 and the sealing material 52 seal a liquid crystal layer (electro-optical material layer) 50.

A portion of the driving circuit substrate 10 protrudes from the edge of the pixel part forming substrate 20 to the outside. A protruding portion 10a is connected to a flexible substrate 80 serving as a flexible wiring substrate. An image display area 11 having a rectangular shape in plan view is formed in a region where the driving circuit substrate 10 and the pixel part forming substrate 20 overlap each other in plan view, and a data line driving circuit 110 and a scanning line driving circuit 120 are provided along two adjacent two sides of the image display area 11. In the image display area 11, a plurality of pixels are formed in a matrix in plan view.

FIG. 2 is a circuit diagram illustrating the electrical configuration of the liquid crystal device 100. As shown in FIG. 2, the liquid crystal device 100 includes the image display area 11, the data line driving circuit 110, the scanning line driving circuit 120, a timing generator (signal processing circuit) 130 electrically connected to the driving circuits 110 and 120, and a power supply circuit 140 electrically connected to the driving circuits 110 and 120 and the timing generator 130.

The liquid crystal device 100 has the driving circuit substrate 10 and the pixel part forming substrate 20, and the driving circuit substrate 10 and the pixel part forming substrate 20 are electrically connected to each other by connection regions 181 and 182. In addition, the image display area 11 is formed in a region where both substrates overlap each other.

In the image display area 11, a plurality of scanning lines (G1, G2, G3, . . . , Gm) and a plurality of data lines (S1, S2, S3, . . . , Sn) are arranged so as to intersect each other, and substantially rectangular regions defined by the scanning lines and the data lines correspond to pixels of the liquid crystal device 100. Thin film transistors (hereinafter, referred to as TFTs) 30, serving as pixel switching elements, are provided corresponding to intersections of the scanning lines and the data lines. Each TFT 30 is electrically connected to a pixel electrode 24 serving as a unit for applying a voltage to liquid crystal 50, and the pixel electrodes 24 are opposite to a counter electrode 28 with the liquid crystal 50 interposed therebetween.

In the liquid crystal device 100 according to this embodiment, among the above-mentioned members, the scanning lines G1 to Gm, the data lines S1 to Sn, the TFTs 30, and the pixel electrodes 24 are provided on the pixel part forming substrate 20 so as to constitute pixels 21. Further, the counter electrode 28, opposite to the pixel electrodes 24 with the liquid crystal 50 interposed therebetween, is formed on the driving circuit substrate 10, and the data line driving circuit 110 and the scanning line driving circuit 120 are also provided on the driving circuit substrate 10.

Further, in the connection region 181 provided on the upper side (−Y side) of the data lines in FIG. 2, the data lines S1 to Sn formed on the pixel part forming substrate 20 are electrically connected to wiring lines extending from the data line driving circuit 110 on the driving circuit substrate 10. Furthermore, in the connection region 182 provided on the left side (−X side) of the scanning lines in FIG. 2, the scanning lines G1 to Gm formed on the pixel part forming substrate 20 are electrically connected to wiring lines extending from the scanning line driving circuit 120 on the driving circuit substrate 10.

In one of the pixels of the liquid crystal device including a TFT 30 provided at the intersection of the scanning line G1 and the data line S1, a gate of the TFT 30 is electrically connected to the scanning line G1, and a source of the TFT 30 is electrically connected to the data line S1. Further, a drain of the TFT 30 is electrically connected to the pixel electrode 24 serving as a unit for applying a voltage to the liquid crystal 50. The pixel electrode 24 is opposite to the counter electrode 28 with the liquid crystal 50 interposed therebetween, and the transmittance of the pixel changes according to the voltage applied between the electrodes 24 and 28. The counter electrode 28 is supplied with a counter electrode potential Vcom generated by the power supply circuit 140.

The data line driving circuit 110 sequentially scans the data lines S1 to Sn in the image display area 11 or performs scanning for every data line or every data line group, on the basis of gray-scale data (image signal) in one horizontal scanning unit. The scanning line driving circuit 120 sequentially scans the scanning line G1 to Gm in the image display area 11 in synchronization with a horizontal synchronizing signal within one vertical scanning period.

In this embodiment, the timing generator 130 is a circuit that generates various signals (image signals and control signals) required for operating the liquid crystal device, from video signals input from the outside or clock signals synchronized with the video signals. The power supply circuit 140 serves as a circuit (DC to DC converter) that converts a single voltage or a plurality of voltages input from the outside into a plurality of voltages necessary to drive the liquid crystal device, and generates a liquid crystal driving potential or counter electrode potential Vcom to be supplied to the data line driving circuit 110 or the scanning line driving circuit 120.

FIG. 3A is a plan view showing a surface of the driving circuit substrate 10 facing the liquid crystal 50 (a surface of the driving circuit substrate 10 opposite to the pixel part forming substrate 20), and FIG. 3B is a plan view showing a surface of the pixel part forming substrate 20 facing the liquid crystal 50 (a surface of the pixel part forming substrate 20 opposite to the driving circuit substrate 10).

The driving circuit substrate 10 shown in FIG. 3A is provided with a color filter part 12 having a rectangular shape in plan view. In the color filter part 12, a plurality of color filters 12a corresponding to the respective pixels of the liquid crystal device 100 are formed in a matrix in plan view. The data line driving circuit 110, the scanning line driving circuit 120, the timing generator 130, and the power supply circuit 140, which constitute a driving circuit part according to the invention, are disposed at the outside of the color filter part 12 on the driving circuit substrate 10. The data line driving circuit 110 and the scanning line driving circuit 120 of the driving circuit part serves as pixel part driving circuits that supply electrical signals to the data lines S1 to Sn and the scanning lines G1 to Gm provided in the pixel part 21, respectively. The driving circuit part is formed of a polysilicon film (polycrystalline semiconductor layer) provided on the driving circuit substrate 10.

The scanning line driving circuit 120 extending in the Y-axis direction is provided along the −X side of the color filter part 12. A scanning-line-driving-circuit connecting part (a first connecting part) 102 is formed on the outside of the scanning line driving circuit 120. Further, the timing generator 130 and the power supply circuit 140, which are electrically connected to each other, are provided on the outside of the scanning-line-driving-circuit connecting part 102. The scanning-line-driving-circuit connecting part 102 forms an electrical connection structure between the pixel part 21 of the pixel part forming substrate 20 and the scanning line driving circuit 120 and has a plurality of connecting terminals (scanning-line-driving-circuit connecting terminals) electrically connected to the scanning line driving circuit 120.

The scanning line driving circuit 120 has a shift register, and sequentially and exclusively supplies, to the scanning lines G1 to Gm, signals obtained by sequentially shifting a start pulse input from the timing generator 130 on the basis of a clock signal input together with the start pulse. This operation of the scanning line driving circuit 120 causes the plurality of data lines S1 to Sn to be selected in a line sequential manner in the Y direction.

The data line driving circuit 110 extending in the X-axis direction is provided along the −Y side of the color filter part 12. A data-line-driving-circuit connecting part (a first connecting part) 101 is formed on the outside of the data line driving circuit 110. The data-line-driving-circuit connecting part 101 forms an electrical connection structure between the pixel part 21 of the pixel part forming substrate 20 and the data line driving circuit 110, and has a plurality of connecting terminals (data-line-driving-circuit connecting terminals) electrically connected to the data line driving circuit 110.

The data line driving circuit 110 includes a shift register 111, a latch circuit 112, a DA converter 113, and an analog switch 114.

The shift register 111 is a circuit that generates a sampling signal for taking timing when the latch circuit 112 in the next stage sequentially latches image signals, on the basis of the clock signal input from the timing generator 130. The latch circuit 112 is a circuit that maintains the image signal (6-bit RGB/serial) input from the timing generator 130 for a predetermined period. The latch circuit 12 receives image signals in synchronization with the sampling signal input from the shift register 111 to combine dot image signals into line image signals, and then outputs the combined image signals to the DA converter 113. The DA converter 113 is a circuit that converts the line image signals (digital signals) input from the latch circuit 112 into voltages to be applied to liquid crystal (analog signals). The analog switch 114 is a circuit that supplies, to the data lines S1 to Sn, the voltages to be applied to liquid crystal input from the DA converter 113 at a predetermined timing.

An external connection terminal 90 is formed along the −Y side of the driving circuit substrate 10. The external connection terminal 90 is electrically connected to the above-mentioned circuits (the data line driving circuit 110, the scanning line driving circuit 120, the timing generator 130, and the power supply circuit 140) via a wiring pattern formed on the driving circuit substrate 10.

The pixel part forming substrate 20 shown in FIG. 3B is provided with the pixel part 21 having a rectangular shape in plan view. In the pixel part 21, the plurality of pixel electrodes 24 corresponding to the pixels of the liquid crystal device 100 are arranged in a matrix in plan view. The TFTs 30 are provided corresponding to the pixel electrodes 24. Further, as shown in FIG. 2, the plurality of scanning lines G1 to Gm and the plurality of data lines S1 to Sn extend so as to intersect each other, and each TFT 30 is electrically connected to the corresponding scanning line and data line.

A scanning-line-driving-circuit-side pixel connecting part (a second connecting part) 202 extending in the Y-axis direction is provided along the −X side of the pixel part 21. The scanning-line-driving-circuit-side pixel connecting part 202 and the pixel part 21 (scanning line G) are electrically connected to each other through a wiring line group 26 extending in the X direction. The scanning-line-driving-circuit-side pixel connecting part 202 forms an electrical connection structure between the plurality of scanning lines G1 to Gm arranged in the pixel part 21 and the scanning line driving circuit 120 on the driving circuit substrate 10, together with the above-mentioned scanning-line-driving-circuit connecting part 102, and has a plurality of connecting terminals (m scanning-line-driving-circuit-side pixel connecting terminals) electrically connected to the scanning lines G1 to Gm of the pixel part 21.

A data-line-driving-circuit-side pixel connecting part (a second connecting part) 201 extending in the X-axis direction is provided along the −Y side of the pixel part 21. The data-line-driving-circuit-side pixel connecting part 201 and the pixel part 21 (data line S) are electrically connected to each other through a wiring line group 25 extending in the Y-axis direction. The data-line-driving-circuit-side pixel connecting part 201 forms an electrical connection structure between the plurality of data lines S1 to Sn arranged in the pixel part 21 and the data line driving circuit 110, together with the above-mentioned data-line-driving-circuit connecting part 101, and has a plurality of connecting terminals (n data-line-driving-circuit-side pixel connecting terminals) electrically connected to the data lines S1 to Sn of the pixel part 21.

FIG. 4 is a cross-sectional view of the liquid crystal device 100, taken along the line IV-IV of FIG. 3A. The driving circuit substrate 10 and the pixel part forming substrate 20 having the structure shown in FIG. 2 are bonded to each other with the sealing material 52 interposed therebetween such that the color filter part 12 of the driving circuit substrate 10 and the pixel part 21 of the pixel part forming substrate 20 are opposite to each other. Further, a connection region that is denoted by reference numeral 181 is formed on the left side of the liquid crystal 50 in FIG. 4. In the connection region 181, the data-line-driving-circuit connecting part 101 of the driving circuit substrate 10 and the data-line-driving-circuit-side pixel connecting part 201 of the pixel part forming substrate 201 are disposed to overlap each other in plan view. Further, the data-line-driving-circuit connecting part 101 and the data-line-driving-circuit-side pixel connecting part 201 are electrically connected to each other by a conductive member 190 provided between the connecting parts 101 and 201. As a result, the data line driving circuit 110 on the driving circuit substrate 10 and the pixel part 21 (data lines S1 to Sn) are electrically connected to each other.

FIG. 5 is a plan view showing the connection region 181, as viewed from the pixel part forming substrate 20. As shown in FIG. 5, in the connection region, a plurality of data-line-driving-circuit connecting terminals 101a and a plurality of data-line-driving-circuit-side pixel connecting terminals 201a are arranged in the X-axis direction. The data-line-driving-circuit connecting terminals 101a are electrically connected to the data line driving circuit 110, and the data-line-driving-circuit-side pixel connecting terminals 201a are electrically connected to the pixel part 21 (more specifically, the scanning lines G1 to Gm corresponding to the data-line-driving-circuit-side pixel connecting terminals 201a).

Further, as shown in FIG. 5, in the connection region 181, the data-line-driving-circuit connecting terminals 101a and the data-line-driving-circuit-side pixel connecting terminals 201a are disposed to overlap each other in plan view. Among conductive particles 185 of the conductive member 190 extending in the X-axis direction so as to be laid across the plurality of connecting terminals 101a and 201a, some conductive particles interposed between the connecting terminals 101a and 201b electrically connect the connecting terminals 101a and 201b. The other conductive particles 185 do not contribute to the electrical connection between the connecting terminals, and thus a short circuit does not occur between the connecting terminals 101a and 201a adjacent to each other in the X-axis direction.

In this embodiment, the conductive member 190 is anisotropic conductive paste obtained by dispersing the conductive particles 185 in a matrix 186 formed of insulating paste, and the conductive particles 185 are resin particles or metal particles whose surfaces are covered with a metal film. Further, the anisotropic conductive paste is selectively coated on the connecting part 101 or 201 when the driving circuit substrate 10 and the pixel part forming substrate 20 are bonded to each other, and the conductive particles 185 come into contact with the connecting terminals 101a and the connecting terminals 201a facing each other, so that the connecting terminals 101a and 201a are electrically connected to each other.

The conductive member 190 is not limited to the above-mentioned anisotropic conductive paste, but may be formed of an anisotropic conductive film (a film containing conductive particles dispersed therein). Further, in this embodiment, the connection region 181 (conductive member 190) is provided at the inside (the side of the liquid crystal 50) of the sealing material 52, but it may be provided at the outside of the sealing material 52. The structure in which the conductive member 190 is formed at the outside of the sealing member 52 causes no trouble although the conductive member 190 is formed of a material inappropriate for contact with the liquid crystal.

Furthermore, the conductive member 190 may constitute a part of the sealing material 52. In other words, as the sealing material 52, a material having conductive particles dispersed therein can be used. This structure enables the driving circuit substrate 10 and the pixel part forming substrate 20 to be electrically connected to each other in a sealing material forming region. Therefore, the structure is advantageous to narrow the frame of the liquid crystal device 100.

Although not shown in FIGS. 3A and 3B, the scanning-line-driving-circuit connecting part 102 of the driving circuit substrate 10 shown in FIG. 3A and the scanning-line-driving-circuit-side pixel connecting part 202 of the pixel part forming substrate 20 shown in FIG. 3B are disposed to overlap each other in plan view in the connection region 182 shown in FIG. 2 so as to be electrically connected to each other in the connection region by the conductive member. More specifically, similar to the connection region 181 shown in FIG. 5, the scanning-line-driving-circuit-side pixel connecting terminals constituting the scanning-line-driving-circuit-side pixel connecting part 202 align the scanning-line-driving-circuit connecting terminals constituting the scanning-line-driving-circuit connecting part 102, so that the connecting terminals facing each other in the Z-axis direction are electrically connected to each other by the conductive member shown in FIG. 4. This structure makes it possible to electrically connect the scanning line driving circuit 120 and the pixel part 21 (the scanning lines G1 to Gm).

According to the liquid crystal device 100 of this embodiment having the above-mentioned configuration, the driving circuit part (the data line driving circuit 110, the scanning line driving circuit 120, the timing generator 130, and the power supply circuit 140) and the pixel part 21 are formed on different substrates. As a result, high performance is obtained from both the driving circuit substrate 10 and the pixel part forming substrate 20, and it is possible to manufacture a liquid crystal device with high yield.

That is, when the pixel part and the driving circuit part are formed on the same substrate, from the point of view of production efficiency, it is preferable to form the driving circuit part and the pixel part by the same process. However, in this manufacturing method, it is very difficult to perform a process optimum to form both the driving circuit part and the pixel part.

In contrast, in the liquid crystal device according to this embodiment, it is possible to perform a process optimum to form both the driving circuit part and the pixel part. Further, a photolithography process having the minimum line width can be performed on the driving circuit substrate 10 having the driving circuits 110 and 120 to form high-performance circuits. Furthermore, if a photolithography process that does not have the minimum line width, but is capable of uniformly processing a large substrate can be performed on the pixel part 21 that requires quality uniformity in a relatively large area, it is possible to obtain a uniform switching characteristic among pixels and to perform display with good uniformity of brightness, contrast, and so on.

In addition, since the driving circuit substrate 10 and the pixel part forming substrate 20 are manufactured in different processes, even though a photolithography process that has the minimum line width and requires a long process time is performed to manufacture the driving circuit substrate 10, it is possible to reduce the effect of the method on the time required for manufacturing the whole liquid crystal device 100.

As the pixel switching elements used for the pixel part 21 of the pixel part forming substrate 20, TFTs obtained by using amorphous silicon for a semiconductor layer may be used, in addition to TFTs obtained by using polysilicon layer for a semiconductor layer. If amorphous silicon TFTs are used as pixel switching elements, it is possible to manufacture the liquid crystal device 100 having a relatively large size at low cost.

Further, in this embodiment, the liquid crystal device having the configuration in which the electrodes (the pixel electrodes 24 and the counter electrode 28) are provided at both sides of the liquid crystal 50 in the thickness direction of the liquid crystal has been described. However, the liquid crystal device according to this embodiment of the invention is not limited to the configuration suitable for a twisted nematic mode (TN mode) or a vertical aligned nematic mode (VAN mode), but the invention can be applied to a horizontal electric field mode called an in-plane switching (IPS) mode or a fringe field switching (FFS) mode. In this case, the counter electrode 28 shown in FIG. 2 is provided not on the driving circuit substrate 10 but on the pixel part forming substrate 20.

Also, the liquid crystal device 100 according to this embodiment may be of a passive matrix type. In this case, the pixel part forming substrate 20 has transparent electrodes formed in strip shapes in plan view in the pixel part 21, and the driving circuit substrate 10 has transparent electrodes formed in stripe shapes in a region opposite to the pixel part 21 so as to intersect the transparent electrodes of the pixel part 21.

Further, in this embodiment, the color filter part 12 is formed on the driving circuit substrate 10. However, the color filter part 12 may be formed on the pixel part forming substrate 20. Since the driving circuit part provided on the driving circuit substrate 10 does not have high static electricity resistance, the process of forming the color filter part 12 may affect the driving circuit part. Therefore, it is preferable to provide the color filter part 12 on the pixel part forming substrate 20.

Method of Manufacturing Liquid Crystal Device

Next, a method of manufacturing the liquid crystal device 100 according to the above-mentioned embodiment will be described below with reference to FIGS. 6A and 6B.

FIG. 6A is a perspective view showing the configuration of a large driving circuit substrate 10A that has a plurality of driving circuit substrates 10 collectively formed thereon, and FIG. 6B is a perspective view showing the configuration a large pixel part forming substrate 20A that has a plurality of pixel part forming substrates 20 collectively formed thereon. In this embodiment, the large substrates each have 6 substrates, but the number of substrates is not limited thereto.

Driving Circuit Substrate

The large driving circuit substrate 10A shown in FIG. 6A has, as a base, a large glass substrate where six rectangular regions each to be a driving circuit substrate 10 can be formed. Dotted lines represented by characters SL are scribe lines, and regions partitioned by the scribe lines SL are regions for forming the driving circuit substrates 10 in the large glass substrate shown in FIG. 6A.

First, polysilicon films 110A and 120A having rectangular shapes in plan view are formed on a surface of the large glass substrate (a surface on the +Z side). These polysilicon films 110A and 120A are formed by forming an amorphous silicon film on the large glass substrate and then by radiating laser beams onto the amorphous silicon film to crystallize it. That is, the polysilicon films are formed by using a low-temperature polysilicon technique.

The low-temperature polysilicon technique is a technique that obtains a polysilicon film by performing a process at a low-temperature of less than 600° C., unlike a technique in the related art that obtains a polysilicon film by heating a substrate at a high temperature (about 1000° C.). In the technique for crystallizing an amorphous silicon film by laser radiation, since the process of radiating laser beams can be performed at room temperature, it is possible to form an amorphous silicon film at a process temperature equal to or less than the temperature (about 600° C.) where a dehydrogenation treatment or an impurity activation process of the amorphous silicon film is performed.

As the low-temperature polysilicon technique, a technique called an Ni precipitation solid growth method also has been known. This technique makes it possible to control the temperature where amorphous silicon is heated to crystallize it. Therefore, all the processes for forming an amorphous silicon film, including the dehydrogenation treatment and an Ni gettering process, can be performed at a temperature less than 600° C.

As shown in FIG. 6A, the polysilicon films 110A and 120A are partially formed in each of the formation regions on the large glass substrate and occupy a small area. Therefore, it is preferable to radiate laser beams onto only the regions where the polysilicon films are formed. If laser beams are radiated onto specific regions as described above, it is possible to improve throughput in the laser radiating process. Further, since the radiation of laser beams is limited to a small region, it is possible to prolong laser radiation time per unit area. Therefore, a polysilicon film with good quality is obtained.

Subsequently, a plurality of driving circuit parts each having the data line driving circuit 110, the scanning line driving circuit 120, the timing generator 130, and the power supply circuit 140 shown in FIG. 3A are formed on the large glass substrate by forming transistors, diodes, or capacitors using the above-mentioned polysilicon films 110A and 120A. The above-mentioned circuits can be manufactured by known methods, and thus a detailed description thereof will be omitted. Further, the data-line-driving-circuit connecting parts 101 and the scanning-line-driving-circuit connecting parts 102 are formed by forming a plurality of connecting terminals as well as metal wiring lines and electrodes constituting the driving circuit parts on the large glass substrate.

In the forming process of the driving circuit parts, impurity introduction and activation are partially performed on the polysilicon films 110A and 120A. However, in the manufacturing method according to this embodiment, the impurity activation process may be performed by laser radiation. Further, the impurity activation has been performed by a furnace or lamp annealing (rapid thermal annealing). However, in this embodiment, the impurity activation is performed by laser radiation. Therefore, it is possible to rapidly and efficiently perform the impurity activation process. In this case, the laser beams are also radiated onto only the polysilicon films 110A and 120A partially formed on the large glass substrate, which makes it possible to rapidly and effectively perform the impurity activation process.

Furthermore, the process of forming the driving circuit parts is separately performed from the process of forming the pixel parts 21. Therefore, it is possible to arbitrarily select materials forming the wiring lines or the circuits constituting the driving part, regardless of the configuration of the pixel part 21. Further, it is possible to select a material most suitable for activating impurities by laser radiation, and thus to perform the impurity activation using an inexpensive material. Also, it is possible to arbitrarily select the thicknesses of the wiring lines or the electrodes or the thickness of an insulating film provided between wiring line layers, regardless of the structure of the pixel part 21, and thus to easily manufacture a high-performance circuit. Further, only two substrates with liquid crystal interposed therebetween are used, and thus an additional expensive substrate is not needed. Furthermore, the same system circuits as ICs or LSIs are mounted on the liquid crystal device, and thus it is unnecessary to additionally mount expensive ICs or LSIs on the liquid crystal device.

Next, on the large driving circuit substrate 10A having the driving circuit parts (the data line driving circuits 110, the scanning line driving circuits 120, the timing generators 130, and the power supply circuits 140) formed thereon, the color filter parts 12 are formed adjacent to the driving circuit parts. When the color filter parts 12 are formed, well-known forming methods can be used. For example, it is possible to form the color filter parts 12 using a print method or a liquid discharge method.

By the above-mentioned processes, the large driving circuit substrate 10A is obtained.

Pixel Part Forming Substrate

Next, a method of manufacturing the pixel part forming substrate 20 will be described.

As shown in FIG. 6B, in the manufacture of the pixel part forming substrate 20, a large glass substrate where six pixel part forming substrates 20 can be collectively formed is used. Regions surrounded by the scribe lines SL are forming regions of the pixel part forming substrates 20. A plurality of pixel parts 21 and data-line-driving-circuit-side pixel connecting parts 201 and scanning-line-driving-circuit-side pixel connecting parts 202 extending from the pixel parts 21 are formed on the upper surface (the surface on the −Z side) of the large pixel part forming substrate 20A in FIG. 6A.

A method of manufacturing a TFT active matrix substrate, which has been used in the related art, can be used to manufacture the pixel part forming substrate 20A. That is, amorphous silicon films or polysilicon films obtained by crystallizing amorphous silicon films are formed on a large glass substrate, and then TFTs having these films as semiconductor layers are formed on the large glass substrate. Sequentially, pixel electrodes are formed on the large substrate in a matrix in plane view so as to be electrically connected to the TFTs. In this way, the pixel parts 21 can be formed.

The data-line-driving-circuit-side pixel connecting parts 201 can be formed by extending a plurality of data lines arranged in the pixel parts 21 so as to be connected to the TFTs 21 of the pixel parts 21 to the outside (the −Y side) of the pixel parts 21, and the scanning-line-driving-circuit-side pixel connecting parts 202 can be formed by extending a plurality of scanning lines arranged in the pixel parts 21 so as to be connected to the TFTs 21 of the pixel parts 21 to the outside (the −X side) of the pixel parts 21. It is preferable to form the leading edges of the connecting terminals constituting the connecting parts 201 and 202 into wide pads as the data-line-driving-circuit-side pixel connecting terminals 201a shown in FIG. 5.

By the above-mentioned process, the large pixel part forming substrate 20A is obtained.

If the large driving circuit substrate 10A and the large pixel part forming substrate 20A are manufactured, as shown in FIGS. 6A and 6B, the upper surface (the surface on the +Z side) of the large driving circuit substrate 10A shown in FIG. 6A is bonded to the upper surface (the surface on the −Z side) of the large pixel part forming substrate 20A shown in FIG. 6B. At the time of bonding, as shown in FIGS. 3A and 3B, the sealing material 52 having a substantially rectangular shape is arranged on the edge of the forming region of each pixel part forming substrate 20. Further, the conductive members 190 formed of, for example, anisotropic conductive paste are disposed in the regions where the data-line-driving-circuit connecting parts 101 and the data-line-driving-circuit-side pixel connecting parts 201 and the regions where the scanning-line-driving-circuit connecting parts 102 and the scanning-line-driving-circuit-side pixel connecting parts 202.

Further, liquid crystal sealed between the driving circuit substrates 10 and the pixel part forming substrates 20 by the sealing material 52 may be selectively disposed on the large driving circuit substrate 10A or the large pixel part forming substrate 20A before the bonding, and it may be injected into the inside of the sealing material 52 after bonding the substrates. Furthermore, the sealing material 52 and the conductive members 190 may not be disposed on the large pixel part forming substrate 20A.

In the above-mentioned boning process, the data-line-driving-circuit connecting parts 101 and the data-line-driving-circuit-side pixel connecting parts 201 are electrically connected to each other by the conductive members 190, and the scanning-line-driving-circuit connecting parts 102 and the scanning-line-driving-circuit-side pixel connecting parts 202 are electrically connected to each other by the conductive members 190. As a result, the data line driving circuits and the scanning line driving circuits formed on the large driving circuit substrate 10A is electrically connected to the pixel parts 21 formed on the large pixel part forming substrate 20A.

Then, the large driving circuit substrate 10A and the large pixel part forming substrate 20A composed of glass substrates are cut along the scribe lines SL. In this way, six liquid crystal devices 100 are obtained.

In the manufacturing method according to this embodiment, the large driving circuit substrate 10A and the large pixel part forming substrate 20A are manufactured by different processes. Therefore, when the large driving circuit substrate 10A is manufactured, a photolithography process capable of obtaining the minimum line width is performed to form high-performance driving circuit parts with high integrity. Meanwhile, when the large pixel part forming substrate 20A is manufacture, a photolithography process capable of uniformly processing the entire large glass substrate is performed to form pixel parts 21 that include pixel switching elements having a small variation in electrical characteristics. Therefore, according to the above-mentioned manufacturing method, it is possible to manufacture liquid crystal devices which have high-performance driving circuit parts and is capable of obtaining uniform display images with high yield.

Further, when the large driving circuit substrate 10A is manufactured, the polysilicon films 110A and 120A can be formed by partially radiating laser beams onto the amorphous silicon films formed on the large glass substrate. Therefore, it is possible to rapidly and effectively perform the process of forming the polysilicon films. When laser beams are partially radiated in the above-mentioned manner, a large laser device is not needed, and thus it is possible to use a small inexpensive laser device and thus to reduce manufacturing costs.

Furthermore, it is possible to use laser radiation to activate impurities injected into the polysilicon films 110A and 120A. It is possible to use a large glass substrate where six pixel part forming substrates 20 can be collectively formed when the pixel part forming substrates 20 are manufactured, as shown in FIG. 6B. The regions surrounded by the scribe lines SL shown in FIG. 6B are forming regions of the pixel part forming substrates 20. Further, when laser beams are selectively radiated onto the polysilicon films 110A and 120A in the impurity activation process, the impurity activation process can be performed with high throughput.

In addition, it is possible to select materials most suitable for the pixel part 21 and the driving circuit part having the data line driving circuit 110, the scanning line driving circuit 120, and so on. In this case, it is possible to form wiring lines and electrodes of the driving circuit part by using a material suitable for impurity activation by laser radiation.

Modifications of Manufacturing Method

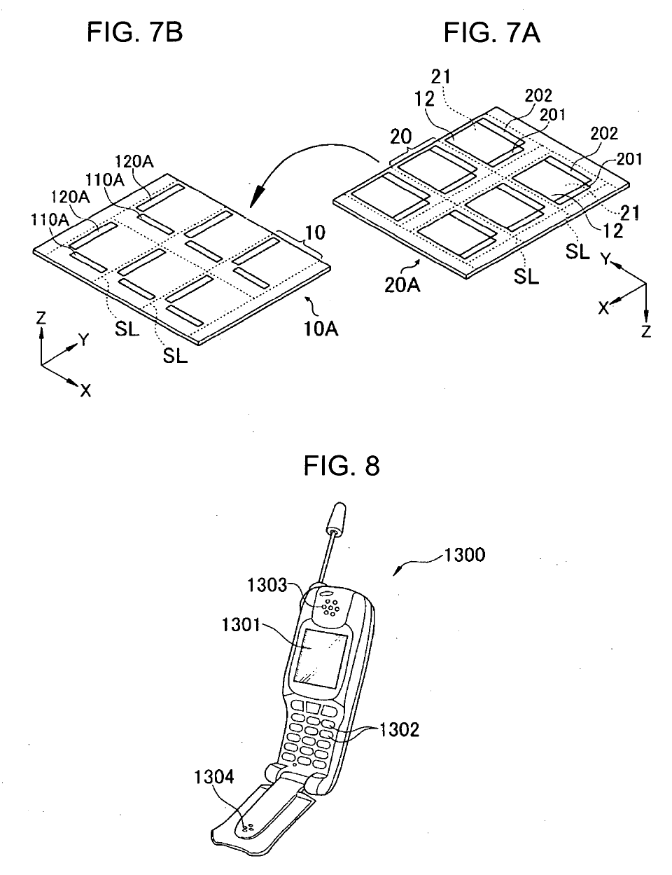

As described above, in the liquid crystal device according to the embodiment of the invention, it is possible to selectively provide the color filter part 12 on the driving circuit substrate 10 or the pixel part forming substrate 20. In the manufacturing method described with reference to FIGS. 6A and 6B, the color filter parts 12 is provided on the large driving circuit substrate 10A. Next, a manufacturing method of liquid crystal devices in which the color filter parts 12 are provided on the large pixel part forming substrate 20A will be described. Further, this manufacturing method is the same as the manufacturing method shown in FIGS. 6A and 6B except for the arrangement of the color filter parts 12. In FIGS. 7A and 7B, the same components as those in FIGS. 6A and 6B have the same reference numerals, and a description thereof will be omitted.

As shown in FIGS. 7A and 7B, in the manufacturing method according to this embodiment, the color filter parts 12 are formed on the large pixel part forming substrate 20A, not the large driving circuit substrate 10A. That is, the color filter parts 12 are formed on the pixel parts 21 of the large pixel part forming substrate 20A shown in FIG. 6B. Meanwhile, only a process of forming driving circuits each having the data line driving circuit 110, the scanning line driving circuit 120, the timing generator 130, and the power supply circuit 140 is performed on the large driving circuit substrate 10A.

According to this manufacturing method, the color filter parts 12 are formed on a different substrate from the driving circuit substrates 10. Therefore, it is unnecessary to perform additional processes on the large driving circuit substrate 10A on which driving circuit parts having relatively low static electricity resistance are formed since the color filter parts 12 are formed using low-temperature polysilicon films, which makes it possible to neglect the effect of static electricity on the driving circuit parts. Therefore, this manufacturing method can contribute to improving the yield of liquid crystal devices.

Electronic Apparatus

FIG. 8 is a perspective view showing an example of an electronic apparatus according to the invention. A mobile phone 1300 shown in FIG. 8 has the liquid crystal device according to the above-mentioned embodiment as a small display unit 1301, a plurality of operation buttons 1302, an earpiece 1303, and a mouthpiece 1304.

The liquid crystal device according to the above-mentioned embodiments of the invention can be properly used as image display units of various electronic apparatuses, such as an electronic book, a projector, a personal computer, digital still camera, a television receiver set, a view-finder-type or monitor-direct-viewing-type videotape recorder, a car navigation apparatus, a pager, an electronic organizer, an electronic calculator, a word processor, a workstation, a television phone, a POS terminal, and apparatuses having touch panels, in addition to the mobile phone. By using the liquid crystal device, a high-performance driving circuit is mounted on a panel, and thus it is possible to realize an electronic apparatus that has a compact display unit with high controllability and excellent mountability.

The technical scope of the invention is not limited to the above-mentioned embodiments, but modifications and changes of the invention can be made without departing from the spirit of the invention. The concrete materials or the configurations described in the above-mentioned embodiments are just illustrative examples, and can be changed properly. For example, the liquid crystal device has been described as an example of an electro-optical device in the above-mentioned embodiments. However, the invention can be applied to any electro-optical device as long as it has a pixel part and a driving circuit part connected to the pixel part. For example, the invention can be applied to an organic electro-luminescent device and a plasma device.

The entire disclosure of Japanese Patent Application No. 2005-63423, filed Mar. 8, 2005 is expressly incorporated by reference herein.

What is claimed is:

1. An electro-optical device comprising:
a first substrate and a second substrate disposed so as to be opposite to each other;
a driving circuit part that has a polycrystalline semiconductor layer and is provided on a surface of the first substrate opposite to the second substrate;
a first connecting part that is provided on the surface of the first substrate opposite to the second substrate so as to be electrically connected to the driving circuit part;
pixel electrodes that are provided on a surface of the second substrate opposite to the first substrate; and
a second connecting part that is provided on the surface of the second substrate opposite to the first substrate so as to be electrically connected to the pixel electrodes,
wherein the first connecting part and the second connecting part are electrically connected to each other in a region where the first connecting part and the second connecting part overlap each other in plan view.

2. The electro-optical device according to claim 1,
wherein the first connecting part and the second connecting part are electrically connected by a conductive member interposed between the first substrate and the second substrate.

3. The electro-optical device according to claim 2,
wherein the conductive member for electrically connecting the first connecting part and the second connecting part forms at least a part of a sealing material that bonds the first substrate to the second substrate.

4. The electro-optical device according to claim 1,
wherein the first connecting part and the second connecting part are disposed on the outside of the sealing material for bonding the first substrate to the second substrate.

5. The electro-optical device according to claim 3,
wherein the first connecting part and the second connecting part each are provided with a plurality of connecting terminals, and
the connecting terminals of the first connecting part and the connecting terminals of the second connecting part are electrically connected to each other by an anisotropic conductive material provided between the first substrate and the second substrate.

6. The electro-optical device according to claim 1,
wherein the driving circuit part includes:
a pixel part driving circuit that supplies driving signals to the pixel electrodes;
a signal processing circuit that performs signal processing on an image signal input from the outside and outputs the processed signal to the pixel part driving circuit; and
a power supply circuit that supplies power to the pixel part driving circuit.

7. The electro-optical device according to claim 1,
wherein color filters are formed in a region of the first substrate overlapping a region where the pixel electrodes are formed in plan view.

8. The electro-optical device according to claim 1,
wherein color filters are formed in a region of the second substrate overlapping a region where the pixel electrodes are formed in plan view.

9. The electro-optical device according to claim 1,
wherein a plurality of scanning lines and a plurality of data lines are formed on the second substrate so as to intersect each other, and thin film transistors electrically connected to the pixel electrodes are provided corresponding to intersections of the scanning lines and the data lines,
the second connecting part has a plurality of scanning-line-driving-circuit-side pixel connecting terminals electrically connected to the plurality of scanning lines and a plurality of data-line-driving-circuit-side pixel connecting terminals electrically connected to the plurality of data lines,
the driving circuit part of the first substrate has a scanning line driving circuit that supplies electric signals to the scanning lines and a data line driving circuit that supplies electric signals to the data lines,
the first connecting part has a plurality of scanning-line-driving-circuit connecting terminals electrically connected to the scanning line driving circuit and a plurality of data-line-driving-circuit connecting terminals electrically connected to the data line driving circuit, and
the scanning-line-driving-circuit-side pixel connecting terminals and the scanning-line-driving-circuit connecting terminals are electrically connected to each other, and the data-line-driving-circuit-side pixel connecting terminals and the data-line-driving-circuit connecting terminals are electrically connected to each other.

10. An electronic apparatus comprising the electro-optical device according to claim 1.
